(19) United States
(12) Patent Application Publication
(10) Pub. No.: US 2020/0063060 A1
(43) Pub. Date: Feb. 27, 2020

(54) METHOD FOR EXTRACTING HEAT-SENSITIVE ANTARCTIC KRILL OIL

(71) Applicant: Zhejiang University of Technology, Hangzhou (CN)

(72) Inventors: Yuting DING, Hangzhou (CN); Xuxia ZHOU, Hangzhou (CN); Xia XU, Hangzhou (CN); Shulai LIU, Hangzhou (CN); Jianhua LIU, Hangzhou (CN); Fei LV, Hangzhou (CN); Wei HU, Hangzhou (CN)

(73) Assignee: Zhejiang University of Technology, Hangzhou (CN)

(21) Appl. No.: 16/553,119

(22) Filed: Aug. 27, 2019

(30) Foreign Application Priority Data
Aug. 27, 2018 (CN) 201810980989.5

(51) Int. Cl. C11B 1/10; C11B 1/02; C11B 3/00

(52) U.S. Cl. CPC C11B 1/10; C11B 3/006; C11B 1/02

(57) ABSTRACT

The present invention provides a method for extracting heat-sensitive Antarctic krill oil comprising the following steps. Firstly, frozen Antarctic krill is thawed and minced; a surfactant is added to the minced Antarctic krill to form a supercritical micelle system; extract the Antarctic krill multiple times after pressurizing and liquefying mixed gases; at the same time, a low-carbon alcohol solvent is added to strip the material in the critical micelle; after the extraction is completed, the extractant is removed; the extraction product and the residue after the extraction are subsequently collected; the heat-sensitive Antarctic krill oil can be obtained by high-speed centrifugal separation of the oil-water mixed extraction product. The present method has the advantages of simple operation, low extraction pressure and high safety. The extraction method of gas pressure liquefaction is completed under low temperature sealing conditions.

### CROSS-REFERENCE TO RELATED APPLICATIONS

This Non-provisional application claims priority under 35 U.S.C. § 119(a) on Chinese Patent Application No(s). 201810980989.5 filed on Aug. 27, 2018, the entire contents of which are hereby incorporated by reference.

### BACKGROUND OF THE INVENTION

### Field of the Invention

The present invention relates to a method for extracting oil, in particular to a method for extracting Antarctic krill oil by fluid pressurized liquefaction, belonging to the technical field of heat-sensitive oil extraction.

### Description of the Related Art

Antarctic krill is a crustacean plankton that lives in the waters of Antarctica in a group way. Its moisture content is 77.9-83.1%, fat content is 0.4-3.6%, and crude protein content is 11.9-15.4%, while chitin and sugar content is about 2%. Antarctic krill fat is mostly unsaturated fatty acids, and its content accounts for about 60% of total fatty acid content. Among them, EPA and DHA account for 28.9% of total fatty acid content, which is much higher than other sources of omega-3 polyunsaturated fatty acids. Further, polyunsaturated fatty acids (EPA, DHA) of Antarctic krill oil are mostly present in the form of phospholipids, which are more easily absorbed and utilized by the human body. Moreover, Antarctic krill also contains a certain amount of astaxanthin, and it is a left-handed structure with high biological activity, and the content is about 3-4 mg/100 g. However, phospholipids and astaxanthin are easily oxidatively degraded and thermally degraded. In addition, a small amount of heat-denatured, thermally oxidized tocopherol, vitamin A and other minor compounds are also present in krill oil. Therefore, in order to maintain the biological activity of phospholipids, astaxanthin and the secondary product, low-temperature extractionshould be used as much as possible.

In view of the nutrient-rich Antarctic krill, the extraction of Antarctic krill oil has become a hot spot in recent years. At present, most of the organic solvent extraction methods are used, wherein chloroform-methanol, ethanol, isopropanol, n-hexane, ethyl acetate, acetone, etc. are used as extracting agents for one-step, multi-step or multiple extractant mixing. Extract the oil from the Antarctic krill powder. This kind of organic solvent extraction method first needs to dry the Antarctic krill, which will cause damage to the heat-sensitive physiological active substance of the oil in the Antarctic krill, which will affect the quality of the oil. In addition, this extraction method has problems such as low extraction of the extractant after extraction, easy residue, complicated solvent recovery, and the like, and is not suitable for industrial production of Antarctic krill oil. Compared with traditional organic solvent extraction of Antarctic krill oil, the water enzymatic extraction of Antarctic krill oil is simple, safe, efficient, and high in quality. However, the use of large amounts of enzymes and high prices is not suitable for industrial production. The extraction conditions of supercritical carbon dioxide extraction method are mild, the content of polar impurities such as protein in shrimp oil is low, the content of free fatty acid is low, and there is no solvent residue. However, carbon dioxide is non-polar, so the extraction efficiency of polar oils such as phospholipids is low, and complete extraction of shrimp oil cannot be achieved alone. In addition, supercritical carbon dioxide extraction is suitable for dry Antarctic krill powder, and heat-drying preparation of Antarctic krill powder is essential to destroy heat sensitive substances in Antarctic krill oil.

As a new oil-making process, gas-pressure liquefaction extraction is gaining more and more attention and attention. It mainly extracts Antarctic krill by liquefying low-boiling gas on the basis of pressure liquefaction. Use the low boiling point of the extractant to recover the solvent by light heating evaporation. Therefore, the liquid pressure extraction method has less solvent residue, is non-toxic, harmless, and environmentally friendly, and non-thermal processing can avoid loss of heat-sensitive physiologically active substances. Solvent recyclability also reduces industrial production costs and is suitable for industrial production.

### BRIEF SUMMARY OF THE INVENTION

The object of the present invention is to provide a method for extracting heat-sensitive Antarctic krill oil, which is suitable for low temperature extraction of heat-sensitive Antarctic krill oil.

In order to achieve the above object, the technical solution of the present invention comprises the following steps:

A method for extracting heat-sensitive Antarctic krill oil comprises the following steps:

step A: mechanically mincing freshly caught or thawed Antarctic krill;

step B: adding a surfactant to the minced Antarctic krill after the step A to form a supercritical micelle system, wherein a mass of the surfactant is 0.001%-1.0% of a mass of the Antarctic krill, the surfactant is one or a mixture of polyglycerol fatty acid ester and diacetyl tartaric acid mono-diglyceride, and if the surfactant is the mixture, a mass ratio of polyglycerol fatty acid ester to diacetyl tartaric acid mono-diglyceride is (0.001-8):(0.002-9);

step C: placing the Antarctic krill processed in the step B into a bracket nested in a nylon mesh sieve, and making it sealed in an extraction tank of an extraction device, wherein the nylon mesh sieve ranges from 20 to 200 mesh;

step D: starting the extraction device to extract the Antarctic krill;

step E: after a single extraction for 5-30 min, adding a demulsifier, wherein a mass of the demulsifier is 0.001%-1.0% of the mass of the Antarctic krill, the demulsifier is one or a mixture of sodium chloride, calcium chloride, potassium chloride, magnesium chloride, and aluminum chloride, and a mass ratio of sodium chloride to calcium chloride to potassium chloride to magnesium chloride to aluminum chloride is (0.15-5):(0-7):(0-9):(0-10):(0-6);

step F: further adding a protein flocculant, wherein a mass of the protein flocculant is 0.001%-0.5% of the mass of the Antarctic krill, the protein flocculant is one or a mixture of chitosan, tannic acid, sodium alginate, and pectin, and a mass ratio of chitosan to tannic acid to sodium alginate to pectin is 6:(0-15):(0-10):(0-8);

step G: further adding a low-carbon alcohol solvent to the extraction device for stripping, wherein a mass of the low-carbon alcohol solvent is 0.2% of the mass of the Antarctic krill, and the low-carbon alcohol solvent is one of ethanol, isopropanol, n-propanol, and n-butanol;

step H: after extraction is completed, removing extractant in the system;

step I: repeating the steps from D to H, and conducting cyclic extraction 0-5 times;

step J: collecting oil-water mixed extraction product in an evaporation tank, and then opening the extraction tank to take out degreased and dehydrated Antarctic krill powder; and

step K: making the oil-water mixed extraction product centrifuged at a high speed of 5000-12000 rpm, and collecting un upper oil layer to obtain heat-sensitive Antarctic krill oil.

Preferably, the surfactant in the step B is a mixture of polyglycerol fatty acid ester and diacetyl tartaric acid mono-diglyceride, and the mass ratio of polyglycerol fatty acid ester to diacetyl tartaric acid mono-diglyceride is (6-7):8, and the mass of the surfactant is 0.005%-0.5% of the mass of the Antarctic krill.

Preferably, the nylon mesh sieve ranges from 60-80 mesh,

Preferably, the extractant is one or gas combinations of propane, butane, dimethyl ether, and liquefied gas, the extractant is added in an amount of 5 to 50 times the mass of the Antarctic krill, and the circulating hot water is at 30-60° C., extraction time is 20-60 min, and a stirring speed is 20-1500 rpm.

Preferably, the extractant is a gas combination of dimethyl ether and butane in a volume ratio of 3:(2-9), the extractant is added in an amount of 10-35 times the mass of the Antarctic krill, and the circulating hot water is at 35-45° C., extraction time is 30-45 min, and a stirring speed is 20-1200 rpm.

Preferably, the demulsifier in the step E is a composition of sodium chloride and calcium chloride in a mass ratio of (3-5):7, and an adding amount of the demulsifier is 0.015%-0.5% of the mass of the Antarctic krill.

Preferably, the protein flocculant in the step F is a composition of chitosan, tannic acid and sodium alginate in a mass ratio of 6:(10-15):(7-10), and an adding amount of the flocculating agent is 0.005%-0.25% of the mass of the Antarctic krill.

Preferably, the temperature of the cooling water is 10-15° C.; the working time of the compressor for recovery of the extractant is 35-45 min; the time for removing the residual extractant by the vacuum pump and the compressor is 2-5 min, and the temperature of the circulating hot water is 30-35° C.

Preferably, the low-carbon alcohol solvent ethanol in the step G is ethanol, and the centrifugal speed in the step K is 5000-10000 rpm.

Preferably, the number of cycles of extraction is 1-3 times.

Preferably, opening a ninth valve, starting a vacuum pump, then opening a second valve, a fourth valve, and a fifth valve, vacuuming a liquid measuring tank, the extraction tank, and the evaporation tank, when a vacuum degree of the extraction tank drops to 0-0.1 Mpa, sequentially closing the second valve and the fourth valve, and when a vacuum degree of the evaporation tank drops to 0-0.1 Mpa, closing the fifth valve; then turning off the vacuum pump thus to complete the vacuuming of the liquid measuring tank, the extraction tank and the evaporation tank; after the vacuuming, slowly opening a first valve, an extractant entering the liquid measuring tank from a liquid storage tank, after the extractant reaches a specified scale, closing the first valve; then slowly opening the second valve, and after the extractant enters the extraction tank from the liquid measuring tank, immediately closing the second valve; providing first circulating hot water, the hot water flowing in and out of interlayers of the extraction tank and heating the extraction tank in water bath; and turning on a mixer at the same time, and rotating a stirring paddle to extract the Antarctic krill oil.

Preferably, after the extraction is completed, a third valve is opened, and the extractant mixed with the Antarctic krill oil flows into the evaporation tank; then a compressor is turned on, and at the same time, a condenser is supplied with cooling water; next a tenth valve, an eleventh valve, and a twelfth valve are opened, and then a seventh valve is slowly opened to allow the evaporated extractant to enter a buffer tank; after a period of compression, when the pressure of the extraction tank and the evaporation tank is less than 0.1 Mpa, the third valve and the seventh valve are sequentially closed; then the ninth valve is closed first, and the eighth valve is then open, the vacuum pump is turned on, the fourth valve and the fifth valve are opened, after the pressure difference between the pressure of the extraction tank and the evaporation tank and the atmospheric pressure drops to 0 Mpa, the fourth valve, the fifth valve, the vacuum pump, and the eighth valve are sequentially closed, after the compressor is operated for a period of time, the tenth valve, the eleventh valve, the compressor, and the twelfth valve are simultaneously closed in sequence, and the cooling water is stopped from supplying, the temperature of the cooling water is 0-15° C., the working time of the compressor for recovery of the extractant is 35-70 min, and the time for removing residual extractant by the vacuum pump and the compressor is 1-8 min, the evaporation tank and the buffer tank are provided with interlayers, respectively, second circulating hot water and third circulating hot water are provided, respectively, the hot water flows into and out of the interlayers for heating in the water bath, thus to accelerate evaporation of the extractant, and the temperature of the hot water is 30-60° C.

Compared with the conventional technology, the present invention has the beneficial effects:

(1) The extracting agents used are all pressurized and liquefied, and the boiling point is low, and the obtained product has less solvent remaining at normal temperature.

(2) The method is simple and convenient to operate, and the pressure during the extraction process does not exceed 1.2 MPa, and the safety is high.

(3) It can be completed in a normal temperature and closed environment and can protect the heat sensitive nutrients in the Antarctic krill oil from oxidation, and the obtained Antarctic krill oil has good quality.

(4) The used extractant can be recovered by evaporation and compression, and the used raw material is high-moisture Antarctic krill, which does not need to be dried. The process flow is shortened while the energy consumption is reduced, and the production cost is greatly reduced.

### BRIEF DESCRIPTION OF THE DRAWINGS

FIG. 1 is a simplified diagram showing an Antarctic krill oil extraction device;

FIG. 2 is a diagram showing an Antarctic krill oil extraction process;

FIG. 3 is a picture of degreased Antarctic krill powder; and

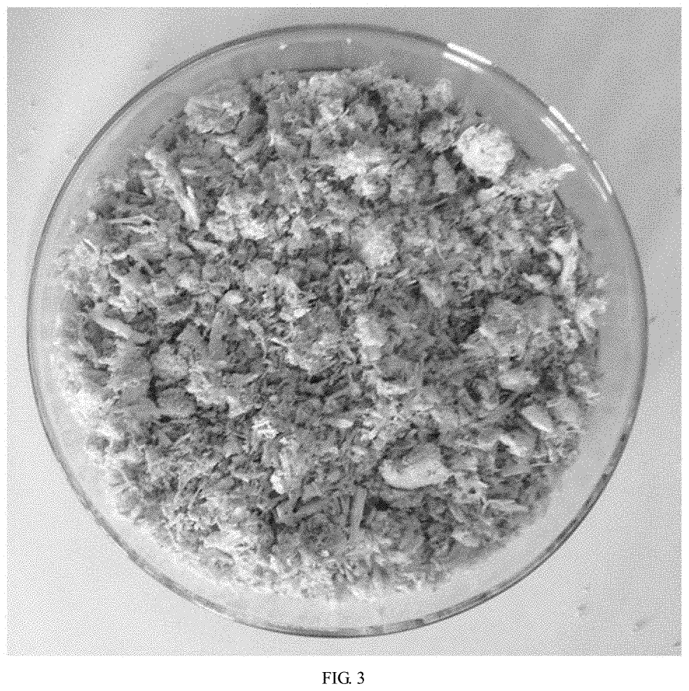

FIG. 4 is a picture of Antarctic krill oil.

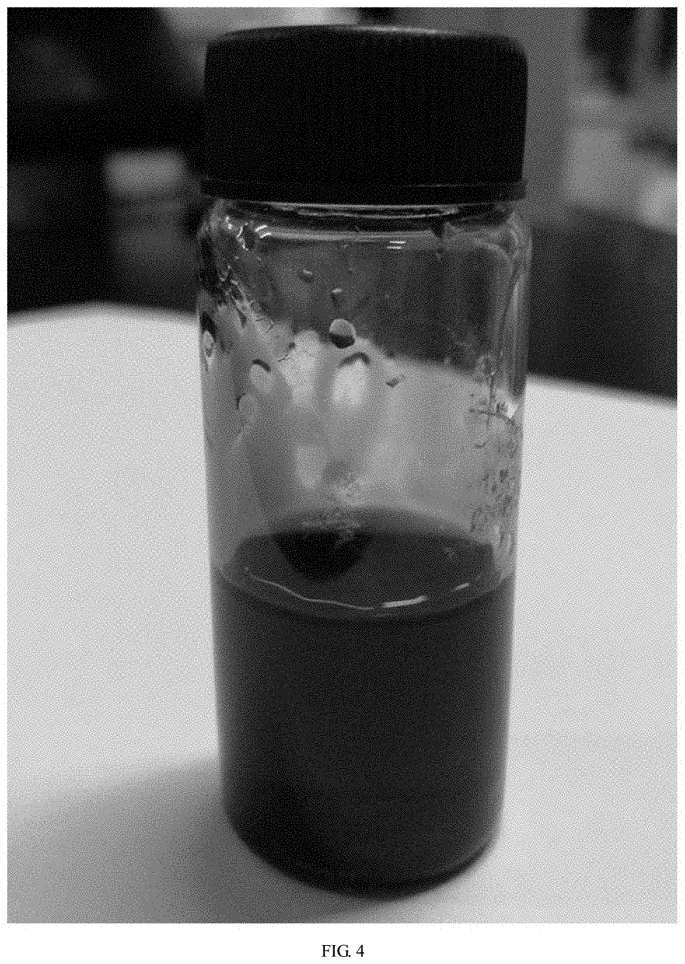

### DETAILED DESCRIPTION OF THE INVENTION

The present invention will be further described in detail below with reference to examples, but the invention is not limited to these embodiments.

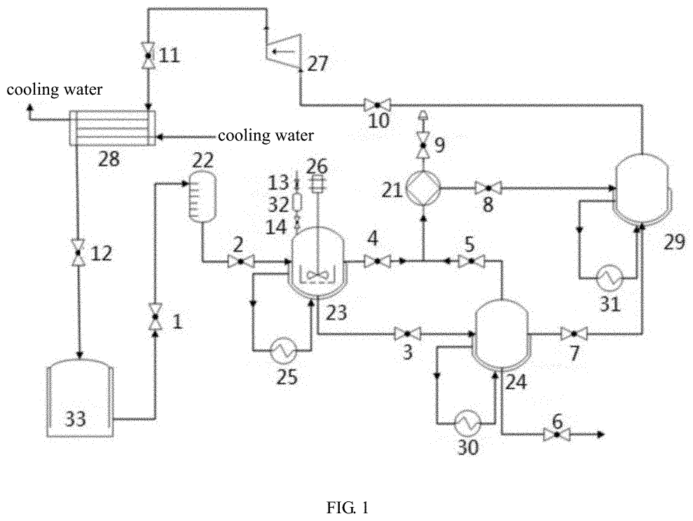

An extraction device of the present example includes an extraction section and an extractant removal section, the structure of which is shown in FIG. 1. The extraction section includes a liquid storage tank 33, a liquid measuring tank 22, and an extraction tank 23, first circulating hot water 25, an entraining agent tank 32, and a mixer 26. The extractant removal section includes a vacuum pump 21, an evaporation tank 24, second circulating hot water 30, a buffer tank 29, and third circulating hot water 31. The extraction device further includes a compressor 27 and a condenser 28, wherein each component of the extraction device have mutual pipe connections through a first valve 1, a second valve 2, a third valve 3, a fourth valve 4, a fifth valve 5, a sixth valve 6, a seventh valve 7, an eighth valve 8, a ninth valve 9, a tenth valve 10, an eleventh valve 11, a twelfth valve 12, a thirteenth valve 13 and a fourteenth valve 14. The connection structure is as shown in FIG. 1.

### EXAMPLE 1

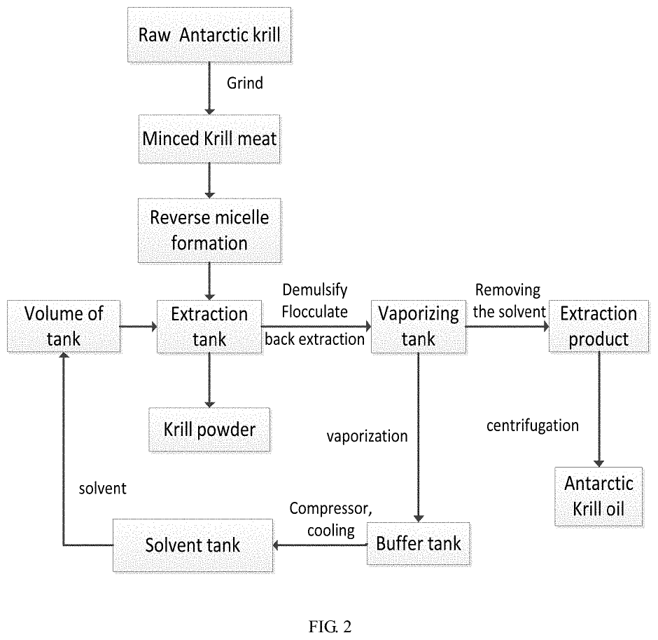

As shown in FIG. 2, a method for extracting heat-sensitive Antarctic krill oil comprises the following steps:

Mincing: mechanically mincing freshly caught or thawed Antarctic krill to obtain minced Antarctic krill;

Supercritical micelle extraction: adding a surfactant to the minced Antarctic krill after the above step to form a supercritical micelle system, wherein a mass of the surfactant is 0.35% of a mass of the Antarctic krill, the surfactant is a composition having polyglycerol fatty acid ester and diacetyl tartaric acid mono-diglyceride in a mass ratio of 4:5;

Loading: wherein the Antarctic krill processed by the above steps is loaded in a bracket nested in a nylon mesh sieve and placed in the extraction tank 23, covered with an extraction cap with a stirring rotor and tightly sealed, and the used nylon mesh screen is in 80 mesh.

Extraction: opening the ninth valve 9, starting the vacuum pump 21, then opening the second valve 2, the fourth valve 4, and the fifth valve 5, vacuuming the liquid measuring tank 22, the extraction tank 23, and the evaporation tank 24, when the vacuum degree of the extraction tank 23 drops to 0-0.1 Mpa, sequentially closing the second valve 2 and the fourth valve 4, and when the vacuum degree of the evaporation tank 24 drops to 0-0.1 Mpa, closing the fifth valve 5; then turning off the vacuum pump thus to complete the vacuuming of the liquid measuring tank 22, the extraction tank 23, and the evaporation tank 24; after the vacuuming, slowly opening the first valve 1, an extractant entering the liquid measuring tank 22 from the liquid storage tank 33, after the extractant reaches a specified scale, closing the first valve 1; then slowly opening the second valve 2, and after the extractant enters the extraction tank 23 from the liquid measuring tank 22, immediately closing the second valve 2; providing first circulating hot water 25, the hot water flowing in and out of interlayers of the extraction tank 23 and heating the extraction tank 23 in water bath; and turning on the mixer 26 at the same time, and rotating the stirring paddle to extract the Antarctic krill oil. The used extractant is a composition having butane to dimethyl ether in a volume ratio of 2:3, the extractant is added in an amount of 15 times the mass of the Antarctic krill, and the circulating hot water is at 40° C., the extraction time is 40 min, and the stirring speed is 1000 rpm.

Demulsification: after a single extraction for 20 min, opening the thirteenth valve 13, adding a demulsifier, wherein a mass of the demulsifier is 0.4% of the mass of the Antarctic krill, the demulsifier is a composition having sodium chloride and calcium chloride in a mass ratio of 4:7;

Flocculation: further adding a protein flocculant in the entraining agent tank 32, wherein a mass of the protein flocculant is 0.25% of the mass of the Antarctic krill, the protein flocculant is a composition having chitosan, tannic acid, and sodium alginate in a mass ratio of 6:15:10;

Stripping of supercritical micelles: continue to add a low-carbon alcohol solvent in the entraining agent tank 32, wherein a mass of the low-carbon alcohol solvent is 0.2% of the mass of the Antarctic krill; subsequently, closing the thirteenth valve 13 and then slowly opening the fourteenth valve 14, and the agent in the entraining agent tank 32 flowing into the extraction tank 23;

Removal of extractant: wherein after the extraction is completed, the third valve 3 is opened, and the extractant mixed with the Antarctic krill oil flows into the evaporation tank 24; then the compressor 27 is turned on, and at the same time, the condenser 28 is supplied with cooling water; next the tenth valve 10, an eleventh valve 11, and the twelfth valve 12 are opened, and then the seventh valve 7 is slowly opened to allow the evaporated extractant to enter the buffer tank 29; after a period of compression, when the pressure of the extraction tank 23 and the evaporation tank 24 is less than 0.1 Mpa, the third valve 3 and the seventh valve 7 are sequentially closed; then the ninth valve 9 is closed first, and the eighth valve 8 is then open, the vacuum pump 21 is turned on, the fourth valve 4 and the fifth valve 5 are opened, after the pressure difference between the pressure of the extraction tank 23 and the evaporation tank 24 and the atmospheric pressure drops to 0 Mpa, the fourth valve 4, the fifth valve 5, the vacuum pump 21, and the eighth valve 8 are sequentially closed, after the compressor 27 is operated for a period of time, the tenth valve 10, the eleventh valve 11, the compressor 27, and the twelfth valve 12 are simultaneously closed in sequence, and the cooling water is stopped from supplying, the temperature of the cooling water is 10° C., the working time of the compressor 27 for recovery of the extractant is 35 min, and the time for removing residual extractant by the vacuum pump 21 and the compressor 27 is 4 min, the evaporation tank 24 and the buffer tank 29 are provided with interlayers, respectively, the circulating hot water 2 and the circulating hot water 3 are provided, respectively, the hot water flows into and out of the interlayers for heating in the water bath, thus to accelerate evaporation of the extractant, and the temperature of the hot water is 30° C.;

Cyclic extraction: repeating the steps from Extraction to Removal of extractant, and conducting cyclic extraction 2 times;

Product collection: opening the valve 6, collecting oil-water mixed extraction product in the evaporation tank 24, and then opening the extraction tank 23 to take out the degreased and dehydrated Antarctic krill powder for the preparation of other products; and

Oil-water separation: making the oil-water mixed extraction product centrifuged at a high speed of 8000 rpm, and collecting the upper oil layer to obtain heat-sensitive Antarctic krill oil.

In this example, the yield of oil and fat was 3.3%, and the dehydration rate was 92.0%. The obtained Antarctic krill oil is a dark red opaque oily liquid. The main physical and chemical indicators: acid value: 32.65 mg/g, peroxide value: 1.52 mmol/kg, iodine value: 129.46 g/100 g, phospholipid content: 32.7%, astaxanthin content: 123.17 mg/kg.

### EXAMPLE 2

As shown in FIG. 2, a method for extracting heat-sensitive Antarctic krill oil comprises the following steps:

Mincing: mechanically mincing freshly caught or thawed Antarctic krill to obtain minced Antarctic krill;

Supercritical micelle extraction: adding a surfactant to the minced Antarctic krill after the above step to form a supercritical micelle system, wherein the mass of the surfactant is 0.5% of a mass of the Antarctic krill, the surfactant is a mixture of polyglycerol fatty acid ester and diacetyl tartaric acid mono-diglyceride in a mass ratio of 7:9;

Loading: wherein the Antarctic krill processed by the above steps is loaded in a bracket nested in a nylon mesh sieve and placed in the extraction tank 23, covered with an extraction cap with a stirring rotor and tightly sealed, and the used nylon mesh screen is in 100 mesh.

Extraction: opening the ninth valve 9, starting the vacuum pump 21, then opening the second valve 2, the fourth valve 4, and the fifth valve 5, vacuuming the liquid measuring tank 22, the extraction tank 23, and the evaporation tank 24, when the vacuum degree of the extraction tank 23 drops to 0-0.1 Mpa, sequentially closing the second valve 2 and the fourth valve 4, and when the vacuum degree of the evaporation tank 24 drops to 0-0.1 Mpa, closing the fifth valve 5; then turning off the vacuum pump thus to complete the vacuuming of the liquid measuring tank 22, the extraction tank 23, and the evaporation tank 24; after the vacuuming, slowly opening the first valve 1, an extractant entering the liquid measuring tank 22 from the liquid storage tank 33, after the extractant reaches a specified scale, closing the first valve 1; then slowly opening the second valve 2, and after the extractant enters the extraction tank 23 from the liquid measuring tank 22, immediately closing the second valve 2; providing first circulating hot water 25, the hot water flowing in and out of interlayers of the extraction tank 23 and heating the extraction tank 23 in water bath; and turning on the mixer 26 at the same time, and rotating the stirring paddle to extract the Antarctic krill oil. The used extractant is a composition having propane to dimethyl ether in a volume ratio of 3:2, the extractant is added in an amount of 20 times the mass of the Antarctic krill, and the circulating hot water is at 30° C., the extraction time is 50 min, and the stirring speed is 500 rpm.

Demulsification: after a single extraction for 30 min, opening the thirteenth valve 13, adding a demulsifier, wherein the mass of the demulsifier is 0.3% of the mass of the Antarctic krill, the demulsifier is a composition having sodium chloride and calcium chloride in a mass ratio of 5:6;

Flocculation: further adding a protein flocculant in the entraining agent tank 32, wherein a mass of the protein flocculant is 0.2% of the mass of the Antarctic krill, the protein flocculant is a composition having chitosan, sodium alginate, and pectin in a mass ratio of 6:10:8;

Stripping of supercritical micelles: continue to add a low-carbon alcohol solvent in the entraining agent tank 32, wherein the mass of the low-carbon alcohol solvent is 0.2% of the mass of the Antarctic krill; subsequently, closing the thirteenth valve 13 and then slowly opening the fourteenth valve 14, and the agent in the entraining agent tank 32 flowing into the extraction tank 23;

Removal of extractant: wherein after the extraction is completed, the third valve 3 is opened, and the extractant mixed with the Antarctic krill oil flows into the evaporation tank 24; then the compressor 27 is turned on, and at the same time, the condenser 28 is supplied with cooling water; next the tenth valve 10, an eleventh valve 11, and the twelfth valve 12 are opened, and then the seventh valve 7 is slowly opened to allow the evaporated extractant to enter the buffer tank 29; after a period of compression, when the pressure of the extraction tank 23 and the evaporation tank 24 is less than 0.1 Mpa, the third valve 3 and the seventh valve 7 are sequentially closed; then the ninth valve 9 is closed first, and the eighth valve 8 is then open, the vacuum pump 21 is turned on, the fourth valve 4 and the fifth valve 5 are opened, after the pressure difference between the pressure of the extraction tank 23 and the evaporation tank 24 and the atmospheric pressure drops to 0 Mpa, the fourth valve 4, the fifth valve 5, the vacuum pump 21, and the eighth valve 8 are sequentially closed, after the compressor 27 is operated for a period of time, the tenth valve 10, the eleventh valve 11, the compressor 27, and the twelfth valve 12 are simultaneously closed in sequence, and the cooling water is stopped from supplying, the temperature of the cooling water is 0° C., the working time of the compressor 27 for recovery of the extractant is 45 min, and the time for removing residual extractant by the vacuum pump 21 and the compressor 27 is 5 min, the evaporation tank 24 and the buffer tank 29 are provided with interlayers, respectively, the circulating hot water 2 and the circulating hot water 3 are provided, respectively, the hot water flows into and out of the interlayers for heating in the water bath, thus to accelerate evaporation of the extractant, and the temperature of the hot water is 45° C.;

Cyclic extraction: repeating the steps from Extraction to Removal of extractant, and conducting cyclic extraction 1 time;

Product collection: opening the valve 6, collecting oil-water mixed extraction product in the evaporation tank 24, and then opening the extraction tank 23 to take out the degreased and dehydrated Antarctic krill powder for the preparation of other products; and

Oil-water separation: making the oil-water mixed extraction product centrifuged at a high speed of 6000 rpm, and collecting the upper oil layer to obtain heat-sensitive Antarctic krill oil.

In this example, the yield of oil and fat was 2.1%, and the dehydration rate was 59.6%. The obtained Antarctic krill oil was dark red opaque oily liquid. The main physical and chemical indicators: acid value: 34.86 mg/g, peroxide value: 1.37 mmol/kg, iodine value: 134.42 g/100 g, phospholipid content: 33.5%, astaxanthin content: 125.32 mg/kg.

### EXAMPLE 3

As shown in FIG. 2, a method for extracting heat-sensitive Antarctic krill oil comprises the following steps:

Mincing: mechanically mincing freshly caught or thawed Antarctic krill to obtain minced Antarctic krill;

Supercritical micelle extraction: adding a surfactant to the minced Antarctic krill after the above step to form a supercritical micelle system, wherein the mass of the surfactant is 0.35% of the mass of the Antarctic krill, and the surfactant is polyglycerol fatty acid ester;

Loading: wherein the Antarctic krill processed by the above steps is loaded in a bracket nested in a nylon mesh sieve and placed in the extraction tank 23, covered with an extraction cap with a stirring rotor and tightly sealed, and the used nylon mesh screen is in 200 mesh.

Extraction: opening the ninth valve 9, starting the vacuum pump 21, then opening the second valve 2, the fourth valve 4, and the fifth valve 5, vacuuming the liquid measuring tank 22, the extraction tank 23, and the evaporation tank 24, when the vacuum degree of the extraction tank 23 drops to 0-0.1 Mpa, sequentially closing the second valve 2 and the fourth valve 4, and when the vacuum degree of the evaporation tank 24 drops to 0-0.1 Mpa, closing the fifth valve 5; then turning off the vacuum pump thus to complete the vacuuming of the liquid measuring tank 22, the extraction tank 23, and the evaporation tank 24; after the vacuuming, slowly opening the first valve 1, an extractant entering the liquid measuring tank 22 from the liquid storage tank 33, after the extractant reaches a specified scale, closing the first valve 1; then slowly opening the second valve 2, and after the extractant enters the extraction tank 23 from the liquid measuring tank 22, immediately closing the second valve 2; providing first circulating hot water 25, the hot water flowing in and out of interlayers of the extraction tank 23 and heating the extraction tank 23 in water bath; and turning on the mixer 26 at the same time, and rotating the stirring paddle to extract the Antarctic krill oil. The used extractant is a composition having liquefied gas to dimethyl ether in a volume ratio of 3:7, the extractant is added in an amount of 30 times the mass of the Antarctic krill, and the circulating hot water is at 50° C., the extraction time is 30 min, and the stirring speed is 800 rpm.

Demulsification: after a single extraction for 15 min, opening the thirteenth valve 13, adding a demulsifier, wherein the mass of the demulsifier is 0.55% of the mass of the Antarctic krill, the demulsifier is a composition having sodium chloride, potassium chloride and magnesium chloride in a mass ratio of 5:9:10;

Flocculation: further adding a protein flocculant in the entraining agent tank 32, wherein a mass of the protein flocculant is 0.15% of the mass of the Antarctic krill, the protein flocculant is a composition having chitosan and tannic acid in a mass ratio of 6:15;

Stripping of supercritical micelles: continue to add a low-carbon alcohol solvent in the entraining agent tank 32, wherein the mass of the low-carbon alcohol solvent is 0.2% of the mass of the Antarctic krill; subsequently, closing the thirteenth valve 13 and then slowly opening the fourteenth valve 14, and the agent in the entraining agent tank 32 flowing into the extraction tank 23;

Removal of extractant: wherein after the extraction is completed, the third valve 3 is opened, and the extractant mixed with the Antarctic krill oil flows into the evaporation tank 24; then the compressor 27 is turned on, and at the same time, the condenser 28 is supplied with cooling water; next the tenth valve 10, an eleventh valve 11, and the twelfth valve 12 are opened, and then the seventh valve 7 is slowly opened to allow the evaporated extractant to enter the buffer tank 29; after a period of compression, when the pressure of the extraction tank 23 and the evaporation tank 24 is less than 0.1 Mpa, the third valve 3 and the seventh valve 7 are sequentially closed; then the ninth valve 9 is closed first, and the eighth valve 8 is then open, the vacuum pump 21 is turned on, the fourth valve 4 and the fifth valve 5 are opened, after the pressure difference between the pressure of the extraction tank 23 and the evaporation tank 24 and the atmospheric pressure drops to 0 Mpa, the fourth valve 4, the fifth valve 5, the vacuum pump 21, and the eighth valve 8 are sequentially closed, after the compressor 27 is operated for a period of time, the tenth valve 10, the eleventh valve 11, the compressor 27, and the twelfth valve 12 are simultaneously closed in sequence, and the cooling water is stopped from supplying, the temperature of the cooling water is 0° C., the working time of the compressor 27 for recovery of the extractant is 55 min, and the time for removing residual extractant by the vacuum pump 21 and the compressor 27 is 6 min, the evaporation tank 24 and the buffer tank 29 are provided with interlayers, respectively, the circulating hot water 2 and the circulating hot water 3 are provided, respectively, the hot water flows into and out of the interlayers for heating in the water bath, thus to accelerate evaporation of the extractant, and the temperature of the hot water is 50° C.;

Cyclic extraction: repeating the steps from Extraction to Removal of extractant, and conducting cyclic extraction 1 time;

Product collection: opening the valve 6, collecting oil-water mixed extraction product in the evaporation tank 24, and then opening the extraction tank 23 to take out the degreased and dehydrated Antarctic krill powder for the preparation of other products; and

Oil-water separation: making the oil-water mixed extraction product centrifuged at a high speed of 10000 rpm, and collecting the upper oil layer to obtain heat-sensitive Antarctic krill oil.

In this example, the extraction rate of oil and fat was 2.7%, and the dehydration rate was 71.6%. The obtained Antarctic krill oil was dark red opaque oily liquid. The main physical and chemical indicators: acid value: 35.47 mg/g, peroxide value: 1.65 mmol/Kg, iodine value: 131.54 g/100 g, phospholipid content: 32.8%, astaxanthin content: 129.67 mg/Kg.

### EXAMPLE 4

As shown in FIG. 2, a method for extracting heat-sensitive Antarctic krill oil comprises the following steps:

Mincing: mechanically mincing freshly caught or thawed Antarctic krill to obtain minced Antarctic krill;

Supercritical micelle extraction: adding a surfactant to the minced Antarctic krill after the above step to form a supercritical micelle system, wherein the mass of the surfactant is 0.4% of the mass of the Antarctic krill, and the surfactant is diacetyl tartaric acid mono-diglyceride;

Loading: wherein the Antarctic krill processed by the above steps is loaded in a bracket nested in a nylon mesh sieve and placed in the extraction tank 23, covered with an extraction cap with a stirring rotor and tightly sealed, and the used nylon mesh screen is in 20 mesh.

Extraction: opening the ninth valve 9, starting the vacuum pump 21, then opening the second valve 2, the fourth valve 4, and the fifth valve 5, vacuuming the liquid measuring tank 22, the extraction tank 23, and the evaporation tank 24, when the vacuum degree of the extraction tank 23 drops to 0-0.1 Mpa, sequentially closing the second valve 2 and the fourth valve 4, and when the vacuum degree of the evaporation tank 24 drops to 0-0.1 Mpa, closing the fifth valve 5; then turning off the vacuum pump thus to complete the vacuuming of the liquid measuring tank 22, the extraction tank 23, and the evaporation tank 24; after the vacuuming, slowly opening the first valve 1, an extractant entering the liquid measuring tank 22 from the liquid storage tank 33, after the extractant reaches a specified scale, closing the first valve 1; then slowly opening the second valve 2, and after the extractant enters the extraction tank 23 from the liquid measuring tank 22, immediately closing the second valve 2; providing first circulating hot water 25, the hot water flowing in and out of interlayers of the extraction tank 23 and heating the extraction tank 23 in water bath; and turning on the mixer 26 at the same time, and rotating the stirring paddle to extract the Antarctic krill oil. The used extractant is a composition having butane and dimethyl ether in a volume ratio of 55:45, the extractant is added in an amount of 50 times the mass of the Antarctic krill, and the circulating hot water is at 60° C., the extraction time is 20 min, and the stirring speed is 1200 rpm.

Demulsification: after a single extraction for 10 min, opening the thirteenth valve 13, adding a demulsifier, wherein the mass of the demulsifier is 0.5% of the mass of the Antarctic krill, the demulsifier is sodium chloride;

Flocculation: further adding a protein flocculant in the entraining agent tank 32, wherein a mass of the protein flocculant is 0.5% of the mass of the Antarctic krill, the protein flocculant is chitosan;

Stripping of supercritical micelles: continue to add a low-carbon alcohol solvent in the entraining agent tank 32, wherein the mass of the low-carbon alcohol solvent is 0.2% of the mass of the Antarctic krill; subsequently, closing the thirteenth valve 13 and then slowly opening the fourteenth valve 14, and the agent in the entraining agent tank 32 flowing into the extraction tank 23;

Removal of extractant: wherein after the extraction is completed, the third valve 3 is opened, and the extractant mixed with the Antarctic krill oil flows into the evaporation tank 24; then the compressor 27 is turned on, and at the same time, the condenser 28 is supplied with cooling water; next the tenth valve 10, an eleventh valve 11, and the twelfth valve 12 are opened, and then the seventh valve 7 is slowly opened to allow the evaporated extractant to enter the buffer tank 29; after a period of compression, when the pressure of the extraction tank 23 and the evaporation tank 24 is less than 0.1 Mpa, the third valve 3 and the seventh valve 7 are sequentially closed; then the ninth valve 9 is closed first, and the eighth valve 8 is then open, the vacuum pump 21 is turned on, the fourth valve 4 and the fifth valve 5 are opened, after the pressure difference between the pressure of the extraction tank 23 and the evaporation tank 24 and the atmospheric pressure drops to 0 Mpa, the fourth valve 4, the fifth valve 5, the vacuum pump 21, and the eighth valve 8 are sequentially closed, after the compressor 27 is operated for a period of time, the tenth valve 10, the eleventh valve 11, the compressor 27, and the twelfth valve 12 are simultaneously closed in sequence, and the cooling water is stopped from supplying, the temperature of the cooling water is 0° C., the working time of the compressor 27 for recovery of the extractant is 70 min, and the time for removing residual extractant by the vacuum pump 21 and the compressor 27 is 7 min, the evaporation tank 24 and the buffer tank 29 are provided with interlayers, respectively, the circulating hot water 2 and the circulating hot water 3 are provided, respectively, the hot water flows into and out of the interlayers for heating in the water bath, thus to accelerate evaporation of the extractant, and the temperature of the hot water is 60° C.;

Product collection: opening the valve 6, collecting oil-water mixed extraction product in the evaporation tank 24, and then opening the extraction tank 23 to take out the degreased and dehydrated Antarctic krill powder for the preparation of other products; and

Oil-water separation: making the oil-water mixed extraction product centrifuged at a high speed of 12000 rpm, and collecting the upper oil layer to obtain heat-sensitive Antarctic krill oil.

In this embodiment, the extraction rate of oil and fat is 1.8%, and the dehydration rate is 36.6%. The obtained Antarctic krill oil is dark red opaque oil-like liquid. The main physical and chemical indicators: acid value: 32.86 mg/g, peroxide value: 1.47 mmol/kg, iodine value: 131.54 g/100 g, phospholipid content: 29.6%, astaxanthin content: 137.85 mg/Kg.

### EXAMPLE 5

As shown in FIG. 2, a method for extracting heat-sensitive Antarctic krill oil comprises the following steps:

Mincing: mechanically mincing freshly caught or thawed Antarctic krill to obtain minced Antarctic krill;

Supercritical micelle extraction: adding a surfactant to the minced Antarctic krill after the above step to form a supercritical micelle system, wherein the mass of the surfactant is 0.001% of the mass of the Antarctic krill, and the surfactant is a composition having polyglycerol fatty acid ester and diacetyl tartaric acid mono-diglyceride in a mass ratio of 8:0.002;

Loading: wherein the Antarctic krill processed by the above steps is loaded in a bracket nested in a nylon mesh sieve and placed in the extraction tank 23, covered with an extraction cap with a stirring rotor and tightly sealed, and the used nylon mesh screen is in 60 mesh.

Extraction: opening the ninth valve 9, starting the vacuum pump 21, then opening the second valve 2, the fourth valve 4, and the fifth valve 5, vacuuming the liquid measuring tank 22, the extraction tank 23, and the evaporation tank 24, when the vacuum degree of the extraction tank 23 drops to 0-0.1 Mpa, sequentially closing the second valve 2 and the fourth valve 4, and when the vacuum degree of the evaporation tank 24 drops to 0-0.1 Mpa, closing the fifth valve 5; then turning off the vacuum pump thus to complete the vacuuming of the liquid measuring tank 22, the extraction tank 23, and the evaporation tank 24; after the vacuuming, slowly opening the first valve 1, an extractant entering the liquid measuring tank 22 from the liquid storage tank 33, after the extractant reaches a specified scale, closing the first valve 1; then slowly opening the second valve 2, and after the extractant enters the extraction tank 23 from the liquid measuring tank 22, immediately closing the second valve 2; providing first circulating hot water 25, the hot water flowing in and out of interlayers of the extraction tank 23 and heating the extraction tank 23 in water bath; and turning on the mixer 26 at the same time, and rotating the stirring paddle to extract the Antarctic krill oil. The used extractant is a composition having butane and propane in a volume ratio of 55:45, the extractant is added in an amount of 5 times the mass of the Antarctic krill, and the circulating hot water is at 30° C., the extraction time is 60 min, and the stirring speed is 20 rpm.

Demulsification: after a single extraction for 10 min, opening the thirteenth valve 13, adding a demulsifier, wherein the mass of the demulsifier is 0.015% of the mass of the Antarctic krill, the demulsifier is a composition having sodium chloride and potassium chloride in a mass ratio of 0.15:9;

Flocculation: further adding a protein flocculant in the entraining agent tank 32, wherein a mass of the protein flocculant is 0.005% of the mass of the Antarctic krill, the protein flocculant is chitosan;

Stripping of supercritical micelles: continue to add a low-carbon alcohol solvent in the entraining agent tank 32, wherein the mass of the low-carbon alcohol solvent is 0.2% of the mass of the Antarctic krill; subsequently, closing the thirteenth valve 13 and then slowly opening the fourteenth valve 14, and the agent in the entraining agent tank 32 flowing into the extraction tank 23;

Removal of extractant: wherein after the extraction is completed, the third valve 3 is opened, and the extractant mixed with the Antarctic krill oil flows into the evaporation tank 24; then the compressor 27 is turned on, and at the same time, the condenser 28 is supplied with cooling water; next the tenth valve 10, an eleventh valve 11, and the twelfth valve 12 are opened, and then the seventh valve 7 is slowly opened to allow the evaporated extractant to enter the buffer tank 29; after a period of compression, when the pressure of the extraction tank 23 and the evaporation tank 24 is less than 0.1 Mpa, the third valve 3 and the seventh valve 7 are sequentially closed; then the ninth valve 9 is closed first, and the eighth valve 8 is then open, the vacuum pump 21 is turned on, the fourth valve 4 and the fifth valve 5 are opened, after the pressure difference between the pressure of the extraction tank 23 and the evaporation tank 24 and the atmospheric pressure drops to 0 Mpa, the fourth valve 4, the fifth valve 5, the vacuum pump 21, and the eighth valve 8 are sequentially closed, after the compressor 27 is operated for a period of time, the tenth valve 10, the eleventh valve 11, the compressor 27, and the twelfth valve 12 are simultaneously closed in sequence, and the cooling water is stopped from supplying, the temperature of the cooling water is 0° C., the working time of the compressor 27 for recovery of the extractant is 70 min, and the time for removing residual extractant by the vacuum pump 21 and the compressor 27 is 7 min, the evaporation tank 24 and the buffer tank 29 are provided with interlayers, respectively, the circulating hot water 2 and the circulating hot water 3 are provided, respectively, the hot water flows into and out of the interlayers for heating in the water bath, thus to accelerate evaporation of the extractant, and the temperature of the hot water is 60° C.;

Product collection: opening the valve 6, collecting oil-water mixed extraction product in the evaporation tank 24, and then opening the extraction tank 23 to take out the degreased and dehydrated Antarctic krill powder for the preparation of other products; and

Oil-water separation: making the oil-water mixed extraction product centrifuged at a high speed of 5000 rpm, and collecting the upper oil layer to obtain heat-sensitive Antarctic krill oil.

In this embodiment, the extraction rate of oil and fat is 2.2%, and the dehydration rate is 38.1%. The obtained Antarctic krill oil is dark red opaque oil-like liquid. The main physical and chemical indicators: acid value: 30.99 mg/g, peroxide value: 1.62 mmol/kg, iodine value: 131.38 g/100 g, phospholipid content: 29.1%, astaxanthin content: 137.85 mg/Kg.

### EXAMPLE 6

As shown in FIG. 2, a method for extracting heat-sensitive Antarctic krill oil comprises the following steps:

Mincing: mechanically mincing freshly caught or thawed Antarctic krill to obtain minced Antarctic krill;

Supercritical micelle extraction: adding a surfactant to the minced Antarctic krill after the above step to form a supercritical micelle system, wherein the mass of the surfactant is 1% of the mass of the Antarctic krill, and the surfactant is a composition having polyglycerol fatty acid ester and diacetyl tartaric acid mono-diglyceride in a mass ratio of 0.001:9;

Loading: wherein the Antarctic krill processed by the above steps is loaded in a bracket nested in a nylon mesh sieve and placed in the extraction tank 23, covered with an extraction cap with a stirring rotor and tightly sealed, and the used nylon mesh screen is in 80 mesh.

Extraction: opening the ninth valve 9, starting the vacuum pump 21, then opening the second valve 2, the fourth valve 4, and the fifth valve 5, vacuuming the liquid measuring tank 22, the extraction tank 23, and the evaporation tank 24, when the vacuum degree of the extraction tank 23 drops to 0-0.1 Mpa, sequentially closing the second valve 2 and the fourth valve 4, and when the vacuum degree of the evaporation tank 24 drops to 0-0.1 Mpa, closing the fifth valve 5; then turning off the vacuum pump thus to complete the vacuuming of the liquid measuring tank 22, the extraction tank 23, and the evaporation tank 24; after the vacuuming, slowly opening the first valve 1, an extractant entering the liquid measuring tank 22 from the liquid storage tank 33, after the extractant reaches a specified scale, closing the first valve 1; then slowly opening the second valve 2, and after the extractant enters the extraction tank 23 from the liquid measuring tank 22, immediately closing the second valve 2; providing first circulating hot water 25, the hot water flowing in and out of interlayers of the extraction tank 23 and heating the extraction tank 23 in water bath; and turning on the mixer 26 at the same time, and rotating the stirring paddle to extract the Antarctic krill oil. The used extractant is a composition having propane and liquefied gas in a volume ratio of 30:70, the extractant is added in an amount of 50 times the mass of the Antarctic krill, and the circulating hot water is at 60° C., the extraction time is 20 min, and the stirring speed is 1500 rpm.

Demulsification: after a single extraction for 10 min, opening the thirteenth valve 13, adding a demulsifier, wherein the mass of the demulsifier is 0.25% of the mass of the Antarctic krill, the demulsifier is sodium chloride and magnesium chloride in a mass ratio of 6:10;

Flocculation: further adding a protein flocculant in the entraining agent tank 32, wherein a mass of the protein flocculant is 0.005% of the mass of the Antarctic krill, the protein flocculant is a mixture of chitosan and sodium alginate;

Stripping of supercritical micelles: continue to add a low-carbon alcohol solvent in the entraining agent tank 32, wherein the mass of the low-carbon alcohol solvent is 0.2% of the mass of the Antarctic krill; subsequently, closing the thirteenth valve 13 and then slowly opening the fourteenth valve 14, and the agent in the entraining agent tank 32 flowing into the extraction tank 23;

Removal of extractant: wherein after the extraction is completed, the third valve 3 is opened, and the extractant mixed with the Antarctic krill oil flows into the evaporation tank 24; then the compressor 27 is turned on, and at the same time, the condenser 28 is supplied with cooling water; next the tenth valve 10, an eleventh valve 11, and the twelfth valve 12 are opened, and then the seventh valve 7 is slowly opened to allow the evaporated extractant to enter the buffer tank 29; after a period of compression, when the pressure of the extraction tank 23 and the evaporation tank 24 is less than 0.1 Mpa, the third valve 3 and the seventh valve 7 are sequentially closed; then the ninth valve 9 is closed first, and the eighth valve 8 is then open, the vacuum pump 21 is turned on, the fourth valve 4 and the fifth valve 5 are opened, after the pressure difference between the pressure of the extraction tank 23 and the evaporation tank 24 and the atmospheric pressure drops to 0 Mpa, the fourth valve 4, the fifth valve 5, the vacuum pump 21, and the eighth valve 8 are sequentially closed, after the compressor 27 is operated for a period of time, the tenth valve 10, the eleventh valve 11, the compressor 27, and the twelfth valve 12 are simultaneously closed in sequence, and the cooling water is stopped from supplying, the temperature of the cooling water is 0° C., the working time of the compressor 27 for recovery of the extractant is 70 min, and the time for removing residual extractant by the vacuum pump 21 and the compressor 27 is 7 min, the evaporation tank 24 and the buffer tank 29 are provided with interlayers, respectively, the circulating hot water 2 and the circulating hot water 3 are provided, respectively, the hot water flows into and out of the interlayers for heating in the water bath, thus to accelerate evaporation of the extractant, and the temperature of the hot water is 30° C.;

Product collection: opening the valve 6, collecting oil-water mixed extraction product in the evaporation tank 24, and then opening the extraction tank 23 to take out the degreased and dehydrated Antarctic krill powder for the preparation of other products; and

Oil-water separation: making the oil-water mixed extraction product centrifuged at a high speed of 5000 rpm, and collecting the upper oil layer to obtain heat-sensitive Antarctic krill oil.

In this embodiment, the extraction rate of oil and fat is 1.8%, and the dehydration rate is 39.8%. The obtained Antarctic krill oil is dark red opaque oil-like liquid. The main physical and chemical indicators: acid value: 32.87 mg/g, peroxide value: 1.97 mmol/kg, iodine value: 136.48 g/100 g, phospholipid content: 29.9%, astaxanthin content: 136.15 mg/Kg.

This specification describes the operation modes of this invention in detail, but the patent is not limited to the above embodiments. Various changes may be made without departing from the spirit of the invention, within the knowledge of those skilled in the art.

What is claimed is:

1. A method for extracting heat-sensitive Antarctic krill oil, comprising the following steps:
step A: mechanically mincing freshly caught or thawed Antarctic krill;
step B: adding a surfactant to the minced Antarctic krill after the step A to form a supercritical micelle system, wherein a mass of the surfactant is 0.001%-1.0% of a mass of the Antarctic krill, the surfactant is one or a mixture of polyglycerol fatty acid ester and diacetyl tartaric acid mono-diglyceride, and if the surfactant is the mixture, a mass ratio of polyglycerol fatty acid ester to diacetyl tartaric acid mono-diglyceride is (0.001-8):(0.002-9);
step C: placing the Antarctic krill processed in the step B into a bracket nested in a nylon mesh sieve, and making it sealed in an extraction tank of an extraction device, wherein the nylon mesh sieve ranges from 20 to 200 mesh;
step D: starting the extraction device to extract the Antarctic krill;
step E: after a single extraction for 5-30 min, adding a demulsifier, wherein a mass of the demulsifier is 0.001%-1.0% of the mass of the Antarctic krill, the demulsifier is one or a mixture of sodium chloride, calcium chloride, potassium chloride, magnesium chloride, and aluminum chloride, and a mass ratio of sodium chloride to calcium chloride to potassium chloride to magnesium chloride to aluminum chloride is (0.15-5):(0-7):(0-9):(0-10):(0-6);
step F: further adding a protein flocculant, wherein a mass of the protein flocculant is 0.001%-0.5% of the mass of the Antarctic krill, the protein flocculant is one or a mixture of chitosan, tannic acid, sodium alginate, and pectin, and a mass ratio of chitosan to tannic acid to sodium alginate to pectin is 6:(0-15):(0-10):(0-8);
step G: further adding a low-carbon alcohol solvent to the extraction device for stripping, wherein a mass of the low-carbon alcohol solvent is 0.2% of the mass of the Antarctic krill, and the low-carbon alcohol solvent is one of ethanol, isopropanol, n-propanol, and n-butanol;
step H: after extraction is completed, removing extractant in the system;
step I: repeating the steps from D to H, and conducting cyclic extraction 0-5 times;
step J: collecting oil-water mixed extraction product in an evaporation tank, and then opening the extraction tank to take out degreased and dehydrated Antarctic krill powder; and
step K: making the oil-water mixed extraction product centrifuged at a high speed of 5000-12000 rpm, and collecting un upper oil layer to obtain heat-sensitive Antarctic krill oil.

2. The method for extracting the heat-sensitive Antarctic krill oil according to claim 1, wherein the surfactant in the step B is a mixture of polyglycerol fatty acid ester and diacetyl tartaric acid mono-diglyceride, and the mass ratio of polyglycerol fatty acid ester to diacetyl tartaric acid mono-diglyceride is (6-7):8, and the mass of the surfactant is 0.005%-0.5% of the mass of the Antarctic krill.

3. The method for extracting the heat-sensitive Antarctic krill oil according to claim 1, wherein the step D comprises the following steps:
opening a ninth valve, starting a vacuum pump, then opening a second valve, a fourth valve, and a fifth valve, vacuuming a liquid measuring tank, the extraction tank, and the evaporation tank, when a vacuum degree of the extraction tank drops to 0-0.1 Mpa, sequentially closing the second valve and the fourth valve, and when a vacuum degree of the evaporation tank drops to 0-0.1 Mpa, closing the fifth valve; then turning off the vacuum pump thus to complete the vacuuming of the liquid measuring tank, the extraction tank, and the evaporation tank; after the vacuuming, slowly opening a first valve, an extractant entering the liquid measuring tank from a liquid storage tank, after the extractant reaches a specified scale, closing the first valve; then slowly opening the second valve, and after the extractant enters the extraction tank from the liquid measuring tank, immediately closing the second valve; providing first circulating hot water, the hot water flowing in and out of interlayers of the extraction tank and heating the extraction tank in water bath; and turning on a mixer at the same time, and rotating a stirring paddle to extract the Antarctic krill oil.

4. The method for extracting the heat-sensitive Antarctic krill oil according to claim 3, wherein the extractant is one or gas combinations of propane, butane, dimethyl ether, and liquefied gas, the extractant is added in an amount of 5 to 50 times the mass of the Antarctic krill, and the circulating hot water is at 30-60° C., extraction time is 20-60 min, and a stirring speed is 20-1500 rpm.

5. The method for extracting the heat-sensitive Antarctic krill oil according to claim 3, wherein the extractant is a gas combination of dimethyl ether and butane in a volume ratio of 3:(2-9), the extractant is added in an amount of 10-35 times the mass of the Antarctic krill, and the circulating hot water is at 35-45° C., extraction time is 30-45 min, and a stirring speed is 20-1200 rpm.

6. The method for extracting the heat-sensitive Antarctic krill oil according to claim 1, wherein the demulsifier in the step E is a composition of sodium chloride and calcium chloride in a mass ratio of (3-5):7, and an adding amount of the demulsifier is 0.015%-0.5% of the mass of the Antarctic krill.

7. The method for extracting the heat-sensitive Antarctic krill oil according to claim 1, wherein the protein flocculant in the step F is a composition of chitosan, tannic acid and sodium alginate in a mass ratio of 6:(10-15):(7-10), and an adding amount of the flocculating agent is 0.005%-0.25% of the mass of the Antarctic krill.

8. The method for extracting the heat-sensitive Antarctic krill oil according to claim 3, wherein the step H comprises the following steps:
wherein after the extraction is completed, a third valve is opened, and the extractant mixed with the Antarctic krill oil flows into the evaporation tank; then a compressor is turned on, and at the same time, a condenser is supplied with cooling water; next a tenth valve, an eleventh valve, and a twelfth valve are opened, and then a seventh valve is slowly opened to allow the evaporated extractant to enter a buffer tank; after a period of compression, when the pressure of the extraction tank and the evaporation tank is less than 0.1 Mpa, the third valve and the seventh valve are sequentially closed; then the ninth valve is closed first, and the eighth valve is then open, the vacuum pump is turned on, the fourth valve and the fifth valve are opened, after the pressure difference between the pressure of the extraction tank and the evaporation tank and the atmospheric pressure drops to 0 Mpa, the fourth valve, the fifth valve, the vacuum pump, and the eighth valve are sequentially closed, after the compressor is operated for a period of time, the tenth valve, the eleventh valve, the compressor, and the twelfth valve are simultaneously closed in sequence, and the cooling water is stopped from supplying, the temperature of the cooling water is 0-15° C., the working time of the compressor for recovery of the extractant is 35-70 min, and the time for removing residual extractant by the vacuum pump and the compressor is 1-8 min, the evaporation tank and the buffer tank are provided with interlayers, respectively, second circulating hot water and third circulating hot water are provided, respectively, the hot water flows into and out of the interlayers for heating in the water bath, thus to accelerate evaporation of the extractant, and the temperature of the hot water is 30-60° C.

9. The method for extracting the heat-sensitive Antarctic krill oil according to claim 8, wherein the temperature of the cooling water is 10-15° C.; the working time of the compressor for recovery of the extractant is 35-45 min; the time for removing the residual extractant by the vacuum pump and the compressor is 2-5 min, and the temperature of the circulating hot water is 30-35° C.

10. The method for extracting the heat-sensitive Antarctic krill oil according to claim 1, wherein the low-carbon alcohol solvent ethanol in the step G is ethanol, and the centrifugal speed in the step K is 5000-10000 rpm.
